(19) United States
(12) Patent Application Publication
(10) Pub. No.: US 2025/0019559 A1
(43) Pub. Date: Jan. 16, 2025

(54) BIODEGRADABLE FUNCTIONAL BIOBASED COATING

(71) Applicant: EARTHODIC PTY LTD, Donnybrook (AU)

(72) Inventor: Albert TIETZ, Donnybrook (AU)

(21) Appl. No.: 18/714,633

(22) PCT Filed: Nov. 24, 2022
(86) PCT No.: PCT/AU2022/051407

§ 371 Date: May 30, 2024

Related U.S. Application Data
(60) Provisional application No. 63/284,616, filed on Nov. 30, 2021.

(51) Int. Cl. C09D 101/02; C09D 107/02; C09D 197/00; D21H 19/52; D21H 25/04

(52) U.S. Cl. CPC C09D 101/02; C09D 107/02; C09D 197/005; D21H 19/52; D21H 25/04

(57) ABSTRACT

A biobased coating and method of forming and use of the same is disclosed. The biobased coating can be used, for example, in packaging and food receptacles or as a sacrificial layer. The coating includes (a) a cellulose, (b) lignin and/or (c) natural latex. Since the coating does not use wax or petrochemically derived polymers, it is eco-friendly to produce and biodegradable. The biobased coating can be formed on an external surface of a substrate, such as, e.g., paper or pulp starch, corrugated cardboard, mushroom (including mycelium), seaweed, a fabric, concrete or metal.

### TECHNICAL FIELD

The present invention relates to biodegradable materials and methods of producing them. More specifically, the present invention relates to a functional biobased coating that is water resistant, strong and can be used as a sacrificial layer for a substrate.

### BACKGROUND

Plastic pollution can be defined as an accumulation of plastic objects and particles in the earth's environment that adversely affects wildlife, wildlife habitat, and humans. Today, single-use plastics account for about 40 percent of the plastic produced every year. Many of these products, such as plastic bags and food wrappers, are used for minutes to hours but they can persist in the environment for hundreds of years. In 2017, a garbage patch estimated to be more than a million square miles was found in the Pacific Ocean. While the patch contains more obvious examples of litter (e.g., plastic bottles, cans and bags), tiny microplastics are nearly impossible to clean up.

Unfortunately, existing packaging for storing and shipping temperature-sensitive products tends to be especially problematic. For example, expanded polystyrene (e.g., Styrofoam™) packaging, a common insulating material, is problematic in terms of both its production and disposal (it includes benzene and outgases). Specifically: (i) it requires nearly 700 gallons of oil to produce one ton of expanded polystyrene; (ii) it generally cannot be economically recycled; (iii) it can be lethal to any creature that ingests a significant quantity; and (iv) in the absence of expensive procedures (which are rarely used), it does not decompose in any reasonable time period.

Plastics that are used in consumer products and packaging biodegrade at different rates. For example, PVC-based plumbing is used for plumbing because the material resists biodegradation. Other plastics, such as, e.g., packaging materials, include synthetic polymers that biodegrade faster (e.g., polycaprolactone, other polyesters and aromatic-aliphatic esters) due to their ester bonds being susceptible to attack by water. For example, polyhydroxybutyrate (PHB) is a polymer of interest because it is bio-derived and bio-degradable.

The term “biodegradable” refers to a material that maintains its mechanical strength during practical use but breaks down into low-weight compounds and non-toxic by-products after use. This breakdown is made possible through an attack of microorganisms on the material, which is typically a non-water-soluble polymer. Such materials can be obtained through chemical synthesis, fermentation by microorganisms, and from chemically modified natural products. In response to environmental concerns, scientists have looked for alternatives to plastic.

For example, starch is a biodegradable material which has been used to prepare foamed and other shaped products for consumer packaging. Starch is not a petroleum product and it also biodegrades quickly. While packaging made from starch presents environmental benefits, it has shortcomings. Starch has lower mechanical properties than natural polymers and high moisture sensitivity. These qualities render it unsuitable for many types of consumer packaging. Efforts have focused on additives that could be incorporated into starch to improve its resistance to water. However, conventional additives may also hinder its ability to biodegrade.

Functional coatings can be applied to a substrate such as starch, cellulosic (paper, fibreboard and corrugated fibreboard), metallic, ceramic, cement, textile or another material with the ability to withstand curing or activation conditions. The coating can convey water resistance to a substrate. For example, coated paper and paperboard products that are water resistant can be used in the food packaging and transportation industries. Waterproof coatings should resist water and preserve the packaging's structural integrity during shipping and storage. Further, safety issues are generally important for food packaging applications.

Conventional coatings typically use wax or synthetic polymers. While these coatings may improve the water resistance of a substrate, they can render the substrate difficult to recycle. Further, they are often petroleum based, rendering them problematic in terms of both production and disposal.

Due to the shortcomings of conventional functional coatings, there is a need for improved formulations and methods. Specifically, there is a need for improved functional coatings that are made with biodegradable materials. Such materials should be environmentally sustainable and confer water-resistance to materials such as starch, paper and corrugated fibreboard. Also needed is a method of forming a waterproof coating on a substrate to produce a water-resistant material that remains biodegradable and can be composted. The coating should also be capable of being used as a sacrificial layer on a metal or similar substrate.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a biobased coating and method of forming the same, which may at least partially address one or more of the problems or deficiencies mentioned above or which may provide the public with a useful or commercial choice.

With the foregoing in view, the present invention is predicated, at least in part, on the finding that an effective water resistant, strengthening and/or degradation resistant coating can be formed on a substrate, such as, e.g., pulp and paper, by coating the substrate with a coating including lignin, cellulose and/or optionally latex and/or a plasticizer.

In one form, the present invention resides broadly in a functional surface coating (i.e., biocoating or biobased coating) for a substrate to improve strength, impart water resistance and/or control degradation.

In another form, the present invention resides broadly in a methods of providing water resistance to a substrate, such as, e.g., pulp and paper, without inhibiting the substrate's ability to be recycled (e.g., repulpable) or composted.

In yet another form, the present invention resides broadly in a method of improving the strength of a substrate, such as, e.g., paper or cardboard, in wet/damp environments, where condensation may weaken the substrate.

In a further form, the present invention resides broadly in a method of degradation control of uncoated paper for agricultural applications, such as, e.g., prolonging a soil paper interface breakdown from a typical duration of about two weeks, thus allowing paper to be used in fields without being dispersed.

In yet a further form, the present invention resides broadly in a method of improving corrosion/rust control of a metallic surface, such as, e.g., steel, including applying the coating to a metal or similar substrate, wherein the coating may act as a sacrificial functional layer.

According to a first aspect of the present invention, there is provided a functional surface coating, biocoating or biobased coating for a substrate including lignin, cellulose and/or latex to improve strength, impart water resistance and/or control degradation. In one form, the biobased coating includes:
(a) between about 0.1 to about 32% w/w lignin;
(b) between about 0.0 to about 20% w/w latex;
(c) between about 0.0 to about 40% w/w plasticizer; and
(d) between about 0.1 to about 70% w/w cellulose.

Advantageously, the biobased coating of the present invention offers the following improvements/benefits over conventional coatings:
The biobased coating described herein may include lignin concentrations below about 10% w/w. Conventional formulations require higher amounts. As described herein, a loading of about 3% w/w lignin can be used which is outside of the limits for the conventional formulations.
The biobased coating as described herein can include latex concentrations above 5% w/w. Latex is incompatible with conventional formulations except at low concentrations (<5% w/w).
The biobased coating has higher elasticity, remains flexible and does not crack. This allows a substrate to remain flexible and bend as needed. Corners and edges will not crack if a coated substrate is folded. Conventional coatings are typically not flexible and prone to cracking.
The colour of the biobased coating is lighter than conventional coatings which are typically deep brown and difficult to shift pigmentation.
The biobased coating offers a barrier to oxygen. This is beneficial for packaging food and other perishables.
The biobased coating can be applied at greater weights. With the present biobased coating, greater coating weights at lower temperatures does not impact performance. Indeed, greater coating weights can improve desired properties (e.g., structural integrity and water resistance).
Conventional coatings often have a sticky/tacky surface. The present biocoating has a smooth surface that is not sticky. A weak “one off” adhesion can be achieved through heat sealing.
The biobased coating can be activated at relatively low temperatures (i.e., below 115° C.). Conventional coatings require higher activation temperatures (typically 180° C. or higher) which requires more time/energy and increases expenses.
The biocoating is a non-Newtonian Formula (i.e., thixotropic). This allows it to be evenly applied by spraying and reduces base sag.
In some embodiments, the biobased coating can be prepared and applied without a plasticiser and still provide desired properties (e.g., structural integrity and water resistance) when activated.

In some embodiments, the biocoating may be applied to a substrate such as pulp, paper, starch, mushroom (including mycelium), seaweed, corrugated cardboard, recycled cardboard/paper, a fabric, concrete or metal. In such embodiments, the biocoating may be prepared as a solution, including lignin, cellulose and/or latex, which in combination, may provide strength, structural integrity and/or water resistance to the substrate.

In some embodiments, the lignin solution may also include a deodorising agent, plasticizer and/or pigment.

In some embodiments, the coating may impart water resistance to the substrate.

In other embodiments, the coating may impart strength, rigidity and/or structural integrity to the substrate.

According to a second aspect of the present invention, there is provided a method of forming a biobased coating on a surface of a substrate including:
(a) forming a biobased coating solution by dissolving a lignin and cellulose in an aqueous solution;
(b) heating the biobased coating solution;
(c) applying the biobased coating solution onto the surface of the substrate; and
(d) heating the substrate to form the biobased coating on the substrate.

According to a third aspect of the present invention, there is provided a method of forming a biobased coating on a surface of a substrate including:
(a) forming a biobased coating solution by dissolving a lignin and cellulose in an aqueous solution;
(b) heating the biobased coating solution;
(c) applying the biobased coating solution onto the surface of the substrate; and
(d) treating the substrate with an acid to form the biobased coating on the substrate.

The methods of the second and third aspects may include one or more features or characteristics of the coating as hereinbefore described.

In some embodiments, the biobased coating may further include a plasticizer.

In some embodiments, the biobased coating may further include latex.

In some embodiments, application of the biobased coating may improve the mechanical capabilities of the substrate, improve aesthetic qualities, improve the scent/smell, prevent moisture absorption/build-up and/or deter growth of mould/bacteria.

In some embodiments, the solution may be formed with specific ratios or solution ingredients (e.g., lignin, latex, plasticizer and/or cellulose). The ratio may provide water resistance when activated (or cured) at a specific temperature or by acidic treatment.

The coating may be applied to the surface of the substrate by rod coating, dip, spray (HVLP, airless, or compressed air), brush, roller, size press, flexoprinting, duo arch or any conventional coating method known in the art.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is a block diagram of the steps in preparing a biocoating for a substrate;

FIG. 2 is a graph showing the water resistance of coating produced from different formulations that include natural pigments on test liner.

FIG. 3 is a graph showing the water resistance of coating when produced at temperatures from 120 to 200° C. at seven different coating weights on Kraft linerboard;

FIG. 4 is a graph showing the water resistance of coating when produced at temperatures from 40 to 200° C. on Kraft linerboard;

FIG. 5A is a table of the coating weight, thermal conditions, and Cobb values of the coating of Formulation A (EO2) on recycled paper;

FIG. 5B is a table of the coating weight, thermal conditions, and Cobb values of the coating of Formulation B (EO3) on recycled paper;

FIG. 5C is a table of the coating weight, thermal conditions, and Cobb values of the coating of Formulation C (EO4) on recycled paper;

FIG. 6 is a graph showing pH and dry solids of coating at lignin loadings 0 to 25% w/w using Formulation D (EO1) on Kraft linerboard;

FIG. 7 is a graph showing water resistance of coating at lignin loadings 0 to 25% w/w using Formulation D (EO1) on Kraft linerboard;

FIG. 8A is a graph showing the water resistance and improvement versus uncoated control of coating using Formulation B (EO3) on Kraft paper with stepwise removal of components;

FIG. 8B is a graph showing the strength and improvement versus uncoated control of coating using Formulation B (EO3) on Kraft paper with stepwise removal of components;

FIG. 9 is a table of coating weight, pH, viscosity and Cobb values of dilution variants of coating of Formulation G (EO2 E1) on Kraft paper;

FIG. 10 is a graph showing water resistance, pH and dry solids of the coating dilution variants shown in FIG. 9;

FIGS. 11A and 11B are tables of temperatures, exposure durations and Cobb values of low and high coating weight lignin variants of Formulation G (EO2 L1);

FIG. 12 is a graph showing water resistance of coating at lignin loadings 0 to 23% w/w using Formulation I (EO2 C2) on Kraft paper;

FIG. 13 is a graph showing strength of coating at lignin loadings 0 to 23% w/w using Formulation I (EO2 C2) on Kraft paper;

FIG. 14 is a graph showing water resistance versus annealing temperature for coatings of Formulations G (EO2 E1), H (EO2 E1P or EO5 E1), I (EO2 C2) and J (EO2 C2P or EO5 C2);

FIG. 15 is graph showing water resistance of coating at glycerol loadings of 0 to 31.5% w/w using Formulation G (EO2 E1); and

FIG. 16 is a graph showing strength and improvement versus uncoated control of a coating at xylose loadings of 0 to 10% w/w using Formulation G with a grass lignin (EO2 L1).

### DEFINITIONS

Reference in this to “one embodiment/aspect” or “an embodiment/aspect” means that a particular feature, structure, or characteristic described in connection with the embodiment/aspect is included in at least one embodiment/aspect of the disclosure. The use of the phrase “in one embodiment/aspect” or “in another embodiment/aspect” in various places in the specification are not necessarily all referring to the same embodiment/aspect, nor are separate or alternative embodiments/aspects mutually exclusive of other embodiments/aspects. Moreover, various features are described which may be exhibited by some embodiments/aspects and not by others. Similarly, various requirements are described which may be requirements for some embodiments/aspects but not other embodiments/aspects. Embodiment and aspect can in certain instances be used interchangeably.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

As applicable, the terms “about” or “generally”, as used herein in the specification and appended claims, and unless otherwise indicated, means a margin of +/−20%. Also, as applicable, the term “substantially” as used herein in the specification and appended claims, unless otherwise indicated, means a margin of +/−10%. It is to be appreciated that not all uses of the above terms are quantifiable such that the referenced ranges can be applied.

The term “environmental-friendly” or “eco-friendly” refers to a process and/or product that is earth-friendly or not harmful to the environment. The term is often used to refer to products that contribute to green living or practices that help conserve resources like water and energy. Eco-friendly products also prevent contributions to air, water and land pollution.

The term “biodegradable” refers to a substance or object that is capable of being decomposed by bacteria or other living organisms. Similarly, biodegradable materials are materials that can be decomposed by the action of living organisms, usually microbes, into water, carbon dioxide, and biomass. In practice, almost all chemical compounds and materials are subject to biodegradation processes. The significance, however, is in the relative rates of such processes, such as days, weeks, years or centuries.

The term “compostable” refers to substance that will break down and become part of compost upon exposure to physical, chemical, thermal and/or biological degradation. Composting can take place in, for example, a composting facility, a site with specific conditions dependent on sunlight, drainage and other factors. Composting can also take place at a home compost, with organic waste and a sufficient level of humidity, or for another example, in a landfill, unexposed to sunlight or oxygen, but again only at a sufficient level of humidity.

The term “lignin” refers to a class of complex organic polymers that form key structural materials in the support tissues of most plants. Lignin can be found in all plants including hardwood, softwood, annual crops, agricultural waste, nut shell residue and some algae. Further, lignin of high quality can be obtained from sources which do not compete with food production and do not involve destruction of the ecosystem. For example, lignin can be sourced from lignocellulosics or lignin containing biomass materials of plant origin. Chemically, lignins are polymers made by cross-linking phenolic precursors. Technical lignins are lignins isolated from various biomasses during various kinds of technical processes and include, for example, lignosulfonate, kraft lignin, alkali lignin, enzymatic/acid hydrolysis lignin, organosolv and steam treatment (steam explosion) lignin.

The term “latex” refers to a stable dispersion (emulsion) of polymer microparticles in water. Natural latex is found in nature as a milky fluid found in 10% of all flowering plants (angiosperms). It is a complex emulsion that coagulates on exposure to air, consisting of proteins, alkaloids, starches, sugars, oils, tannins, resins and gums. Latex can also refer to natural latex rubber, particularly non-vulcanized rubber.

The term “cellulose” refers to an organic compound with the formula (C₆H₁₀O₅) n, a polysaccharide consisting of a linear chain of several hundred to many thousands of β(1→4) linked D-glucose units. Cellulose is an important structural component of the primary cell wall of green plants, many forms of algae and the oomycetes. Some species of bacteria secrete it to form biofilms. Cellulose is mainly used to produce paperboard and paper. Smaller quantities are converted into a wide variety of derivative products such as cellophane and rayon. Cellulose for industrial use is mainly obtained from wood pulp and cotton.

The term “microfibrillated cellulose” or “MFC” refers to a natural material made up of cellulose fibrils that have been separated from a source, such as wood pulp. MFC fibres bond together and create strength and smoother surfaces and improve barrier properties. “Nanofibrillated cellulose” or “NFC” (smaller fibrils) and fibrillated cellulose or “FC” (larger fibrils) refer to similar suitable material of different fibril size.

The term “nano crystalline cellulose” or “NCC” refers to nano-structured cellulose. NCC is cellulose in crystalline form, which is extracted from woody biomass and processed into a solid flake, liquid and gel forms. “Micro crystalline cellulose” or “MCC” (larger crystals) and “crystalline cellulose” or “CC” (larger again crystals) refer to similar suitable material of different crystal size.

The term “waterproof” or “water-resistant” refers to a substrate that has been treated (i.e., coated) to become resistant to penetration by water and wetting. “Waterproofing” refers to a process of making a substrate waterproof or water-resistant (i.e., by applying a coating) so that it remains relatively unaffected by water or resists the ingress of water.

The term “strengthening” refers to increasing the physical strength or structural integrity of a substrate by, for example, applying a coating. An increase in strength can be measured by tests known in the art such as tensile strength testing (using constant rate of elongation apparatus), ring crush testing (RCT), burst or short span compression testing (SCT).

The term “plasticizer” refers to a substance that is added to a material to make it softer and more flexible, to increase its plasticity, to decrease its viscosity or to decrease friction during its handling in manufacture. A plasticizer is preferably biodegradable. Suitable plasticizers include glycerol, glycerol triacetate (Triacetin), alkyl citrates, triethyl citrate (TEC), acetyl triethyl citrate (ATEC), tributyl citrate (TBC), acetyl tributyl citrate (ATBC), trihexyl citrate (THC), acetyl trihexyl citrate (ATHC), butyryl trihexyl citrate (BTHC, trihexyl o-butyryl citrate) and vegetable oil-based plasticizers.

The term “Cobb test” refers to a method of determining the amount of water absorbed into the surface by a sized (non-bibulous) paper, paperboard, and corrugated fibreboard paper or paperboard sample in a set period of time, usually 60 or 180 seconds (short) or 30 to 60 minutes (long) based on application. Water absorbency is often quoted in g/m². The Cobb value provides information about the water absorption capacity of cartonboard samples. The Cobb test determines the amount of water that is taken up by a defined area of cartonboard through one-sided contact with water within a certain amount of time.

### DETAILED DESCRIPTION

Embodiments of the present invention provide a coating for paper or pulp that enhances structural integrity and water resistance. The applicant has found that the coating confers water-resistance and/or strength when applied to a substrate such as paper or pulp. Further, the coating imparts a matte to glossy coating which can improve the aesthetic qualities of a substrate. The biobased coating is physically strong, though flexible, and further, has low gas permeability, high water resistance and has a long shelf-life. The main ingredients of the coating include (a) a microfibrillated cellulose (MFC), (b) lignin and optionally (c) a natural latex. Because the coating does not use wax or petrochemically derived polymers, it is eco-friendly to produce, can be repulped back into products and rapidly biodegrades.

Without being bound by theory, the applicant proposes that the inclusion of MFC allows for coatings with improved integrity and water resistance. Further, it allows for coatings with lower amounts of lignin. When latex is present, the MFC allows a higher latex loading without becoming sticky or surface blocking. This provides additional improved qualities related to viscosity, weight and ease of application. Accordingly, embodiments provide a coating for a substrate that includes the ingredients in Table 1. Weight (%) is as supplied for each component with active ranges indicated and differences based on supplier or material stream used.

TABLE 1
General Formulation

| Ingredient | Weight (%) | Active (%) |
|---|---|---|
| lignin | 0.1-32% | 2-97 |
| latex | 0-40% | 40-70 |
| glycerol | 0-40% | 50-100 |
| alkalizer | 0-5% | 15-45 |
| cellulose (MFC and/or | 0.1-70% | 1-97 |
| NCC) | | |
| water | add to 100% | 100 |
| Total | 100.00% | |

### Lignin

Lignin is one of the most abundant renewable carbon resources. Lignin is a class of complex organic polymers that form key structural materials in the support tissues of most plants. Lignins are important in the formation of cell walls, especially in wood and bark, because they lend rigidity and do not rot easily. Generally, any product that contains lignin can be used as a source including agro-based industries that produce annual fibres such as jute, hemp, cotton, straw and grass (such as, e.g., sakandra grass) and/or wood pulp from hardwood and softwood species, and/or nut residue such as macadamia, peanut, walnut or other nut with preferably low ash content. Aquatic water plants and other lignin containing plant residue or lignin containing streams from other industrial process may also be used. Isolation and purification methods are well known in the art.

As described herein, lignin can impart structural integrity and water resistance if present with other compounds. Lignin can also act as a natural biocide. While not being bound by theory, it is possible that the lignin also acts as a Pickering emulsion with the remaining components, allowing unique loadings. In embodiments, the coating is applied to a substrate material that is composed of paper, pulp, starch (e.g., corn-starch), mushroom (including mycelium) or seaweed, corrugated cardboard, recycled cardboard/paper, a fabric, a metal, etc. In some embodiments, lignin is not the major strengthening agent.

In some embodiments, a formulation contains lignin in a concentration of less than about 3%, less than about 4%, less than about 5%, less than about 10%, less than about 15%, less than about 20%, less than about 25%, less than about 30% or less than about 35% of the formulation.

In other embodiments, a formulation contains lignin in a concentration of at least about 3%, at least about 5%, at least about 10%, at least about 15%, at least about 20%, at least about 25%, at least about 30%, at least about 35%, at least about 40%, or at least about 45% of the formulation.

In other embodiments, a formulation contains lignin in a concentration of at least about 15%, at least about 16%, at least about 17%, at least about 18%, at least about 19%, at least about 20%, at least about 21%, at least about 22%, at least about 23%, at least about 24%, at least about 25%, at least about 26%, at least about 27%, at least about 28%, at least about 29%, at least about 30%, at least about 31%, at least about 32% or at least about 33% of the formulation.

In yet other embodiments, the concentration of lignin is at least about 0.1%, at least about 1%, at least about 2%, at least about 2.5%, at least about 3%, at least about 4%, at least about 5%, at least about 6%, at least about 7%, at least about 8%, at least about 9% or more.

In other embodiments, the concentration of lignin is about 1%, about 2%, about 2.5%, about 3%, about 4%, about 5%, about 6%, about 7%, about 8%, about 9% or about 10%.

In other embodiments, the concentration of lignin is no more than about 0.1%, no more than about 1%, no more than about 2%, no more than about 2.5%, no more than about 3%, no more than about 4%, no more than about 5%, no more than about 6%, no more than about 7%, no more than about 8%, no more than about 9% or more.

In other embodiments, the concentration of lignin is from about 1% to about 32%, is from about 1% to about 30%, is from about 1% to about 28%, is from about 1% to about 25%, is from about 1% to about 22%, is from about 1% to about 20%, is from about 1% to about 18%, is from about 1% to about 15%, 1% to about 10%, is from about 2% to about 9%, is from about 2.5% to about 5%, is from about 2% to about 3%, is from about 3% to about 8%, is from about 4% to about 7%, is from about 5% to about 6%, is from about 2% to about 4%, or is from about 1.5% to about 3.5%.

### Latex

Latex is a thick, creamy white, milky emulsion, although it can be a thin, clear, yellow or orange, aqueous suspension. Natural latex can be sourced from plant families that include: Euphorb family (Euphorbiaceae), milkweed family (Asclepiadaceae), mulberry family (Moraceae), dogbane family (Apocynaceae) and chicory tribe (Lactuceae) of the sunflower family (Asteraceae). The majority of the world's latex is sourced from the Para rubber tree (Hevea brasiliensis). Russian dandelion (Taraxacum kok-saghyz or TKS) may also be used or shrub-based latex such as Guayule or grass such as Spinifex.

As described herein, latex can add elasticity and impart a high-water resistance considered equal to, or greater than the lignin. It can also provide deodorizing characteristics. In one embodiment, latex is the majority water resistant component in the coating.

In some embodiments, the formulation does not include latex.

In other embodiments, the concentration of latex is at least about 1%, at least about 2%, at least about 2.5%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 25%, at least about 30%, at least about 35% or at least about 40% w/w of the formulation or more.

In other embodiments, the concentration of latex is at least about 15%, at least about 16%, at least about 17%, at least about 18%, at least about 19% or at least about 20% w/w of the formulation or more.

In other embodiments, the concentration of latex is about 1%, about 2%, about 2.5%, about 3%, about 4%, about 5%, about 6%, about 7%, about 8%, about 9% or more.

In other embodiments, the concentration of latex is no more than about 1%, no more than about 2%, no more than about 2.5%, no more than about 3%, no more than about 4%, no more than about 5%, no more than about 6%, no more than about 7%, no more than about 8%, no more than about 9% or more.

In yet other embodiments, the concentration of latex is from about 1% to about 10%, is from about 2% to about 9%, is from about 2.5% to about 5%, is from about 2% to about 3%, is from about 3% to about 8%, is from about 4% to about 7%, is from about 5% to about 6%, is from about 2% to about 4%, or is from about 1.5% to about 3.5%.

### Cellulose

The major sources of cellulose are plant fibres (e.g., cotton, hemp, flax, and jute are almost all cellulose) and wood. Since cellulose is insoluble in water, it is easily separated from the other constituents of a plant. Although cellulose can be readily sourced from wood, other cellulose-containing materials include agricultural residues, water plants, grasses, other plant substances and some bacteria.

Cellulose is preferably a micro fibrillated cellulose (MFC). The MFC presents the ideal viscosity and additional expected gas barrier properties. Without being bound by theory, the applicant proposes that MFC enables a lower loading of lignin. It accommodates higher amounts of latex to improve water resistance. This was unexpected and contrary to previous formulations and methods. In some embodiments, cellulose is the major strengthening agent.

Other types of cellulose have been effective, including Nano Crystalline Cellulose (NCC). Two commercial types of MFC have demonstrated synergistic effects. In one embodiment, MFC is the majority water resistant component in the coating.

In some embodiments, a formulation contains a MFC and/or NCC in a concentration of at least about 10%, at least about 20%, at least about 30%, at least about 40%, at least about 50%, at least about 60%, at least about 35%, at least about 40%, at least about 45%, at least about 50%, at least about 55%, at least about 65%, at least about 70%, at least about 75% or more w/w of the formulation.

In other embodiments, the concentration of MFC and/or NCC is at least about 10%, at least about 20%, at least about 25%, at least about 30%, at least about 40%, at least about 45%, at least about 50%, at least about 60%, at least about 70%, at least about 80% or more.

In other embodiments, the concentration of MFC and/or NCC is about 10%, about 20%, about 25%, about 30%, about 40%, about 50%, about 60%, about 45%, about 55%, about 70% or more.

In yet other embodiments, the concentration of MFC and/or NCC is no more than about 10%, no more than about 20%, no more than about 25%, no more than about 30%, no more than about 40%, no more than about 50%, no more than about 60%, no more than about 70%, no more than about 80%, no more than about 45% or more.

In yet other embodiments, the concentration of MFC and/or NCC is from about 10% to about 20%, is from about 20% to about 90%, is from about 25% to about 50%, is from about 20% to about 30%, is from about 30% to about 80%, is from about 40% to about 70%, is from about 50% to about 60%, is from about 20% to about 40% or is from about 15% to about 35% w/w of the formulation.

In yet other embodiments, the concentration of MFC and/or NCC is at least about 0.1%, at least about 1%, at least about 2%, at least about 2.5%, at least about 3%, at least about 4%, at least about 5%, at least about 6%, at least about 7%, at least about 8%, at least about 9% or more.

In yet other embodiments, the concentration of MFC and/or NCC is about 1%, about 2%, about 2.5%, about 3%, about 4%, about 5%, about 6%, about 7%, about 8%, about 9% or about 10%.

In yet other embodiments, the concentration of MFC and/or NCC is no more than about 0.1%, no more than about 1%, no more than about 2%, no more than about 2.5%, no more than about 3%, no more than about 4%, no more than about 5%, no more than about 6%, no more than about 7%, no more than about 8%, no more than about 9% or more.

In yet other further embodiments, the concentration of MFC and/or NCC is from about 1% to about 10%, is from about 2% to about 9%, is from about 2.5% to about 5%, is from about 2% to about 3%, is from about 3% to about 8%, is from about 4% to about 7%, is from about 5% to about 6%, is from about 2% to about 4%, or is from about 1.5% to about 3.5%.

### Other Ingredients

In some embodiments, the formulation may include a plasticizer, an alkalizer and water.

Plasticizers can be added to impart desired softening and elongation properties. Preferably, such plasticizers may include glycerol. Glycerol adds elasticity to the coating and facilitates a lower glass transition of the lignin that allows reduction in the thermal requirements to achieve a good water resistance.

Plasticizers such as sugar alcohols or other polyols can be used as alternatives to glycerol. Other plasticizers can include, for example, glycerol derivatives, soybean oil, castor oil, TWEEN, sorbitan monolaurate, sorbitan monooleate, sorbitan monopalmitate, sorbitan trioleate, sorbitan monostearate, PEG, derivatives of PEG, N,N-ethylene bis-stearamide, N,N-ethylene bis-oleamide, polymeric plasticizers such as poly(1,6-hexamethylene adipate), and other compatible low molecular weight polymers, such as, e.g., a monosaccharide, preferably xylose.

In some embodiments, the formulation does not include glycerol.

In other embodiments, the formulation contains glycerol in a concentration of at least about 5%, at least about 10%, at least about 15%, at least about 20%, at least about 25%, at least about 30%, at least about 35% or at least about 40% w/w of the formulation.

In other embodiments, the concentration of glycerol is at least about 1%, at least about 2%, at least about 2.5%, at least about 3%, at least about 4%, at least about 5%, at least about 6%, at least about 7%, at least about 8% or at least about 9% w/w of the formulation or more.

In other embodiments, the concentration of glycerol is about 1%, about 2%, about 2.5%, about 3%, about 4%, about 5%, about 6%, about 7%, about 8%, about 9% w/w of the formulation or more.

In other embodiments, the concentration of glycerol is no more than about 1%, no more than about 2%, no more than about 2.5%, no more than about 3%, no more than about 4%, no more than about 5%, no more than about 6%, no more than about 7%, no more than about 8%, or no more than about 9% w/w of the formulation or more.

In other embodiments, the concentration of glycerol is from about 1% to about 20%, is from about 1% to about 25%, is from about 5% to about 20%, is from about 10% to about 20%, is from about 5% to about 25%, is from about 1% to about 10%, is from about 2% to about 9%, is from about 2.5% to about 5%, is from about 2% to about 3%, is from about 3% to about 8%, is from about 4% to about 7%, is from about 5% to about 6%, is from about 2% to about 4%, or is from about 1.5% to about 3.5% w/w of the formulation.

An alkalizer counteracts/neutralizes acidity. For example, ammonia can be used, which is driven off during the thermal treatment and not expected to be present in final products.

Other alkalizers that can be used include, for example, sodium bicarbonate, potassium citrate, calcium carbonate, sodium lactate, calcium acetate alkaline earth metal hydroxide or alkali metal hydroxide. While the pH can be in a range, (e.g., pH range of 10.6 to 6.14 in tested formulations), for stability and reduction of microbial growth, a pH of about 8.0 to 9.5 can be preferred. In one embodiment, the alkalizer can be from the lignin itself if the lignin is an alkali lignin of basic nature.

As noted in Table 1, water is added to the formulation to reach 100%. While municipal water has been adequate in testing, RO or DI water is generally preferred. Moreover, water with a pH close to neutral is most preferred.

Additional agents may be useful based on the anticipated use of the coated substrate. For example, pigments can improve aesthetics and some have biocidal activity. Several natural pigments have demonstrated compatibility with the formulation such as vegetable carbon black (VCB) and copper chlorophyllin (Cu-Chl).

Other agents can be used to improve/modify viscosity. The viscosity of cellulose (i.e., MFC) is generally not impacted by changes in pH. Essential oils, such as peppermint oil or citronella, can be suitable viscosity modifiers and may present dual functions as odour enhancers and/or insect repellents.

Other agents include urea for enhanced nitrogen levels and slow release in Ag films, iron to improve magnetic character, glutens, borate, mid chain triglycerides, and various sugar alcohols for possible endothermic coatings. The applicant has found a general tolerance of up to 10% w/w of a formulation to add such and/or additional functionality.

In some embodiments, the formulation comprises the components of Table 2 (high latex, optimal lignin composition).

TABLE 2
Formulation A (EO2)

| Ingredient | Weight (%) |
|---|---|
| lignin | 10% |
| latex | 17% |
| glycerol | 20% |
| alkalizer | 0.5-2% |
| cellulose (MFC) | 40% |
| water | 11-12.5% |
| Total | 100.00% |

In other embodiments, the formulation comprises the components of Table 3 (low latex, low lignin composition).

TABLE 3
Formulation B (EO3)

| Ingredient | Weight (%) |
|---|---|
| lignin | 4% |
| latex | 7% |
| glycerol | 20% |
| alkalizer | 0.5-2% |
| cellulose (MFC) | 40% |
| water | 27-28.5% |
| Total | 100.00% |

In other embodiments, the formulation comprises the components of Table 4 (no latex, optimal lignin composition).

TABLE 4
Formulation C (EO4)

| Ingredient | Weight (%) |
|---|---|
| lignin | 10% |
| latex | 0% |
| glycerol | 20% |
| alkalizer | 0.5-2% |
| cellulose (MFC) | 40% |
| water | 28-29.5% |
| Total | 100.00% |

In other embodiments, the formulation comprises the components of Table 5 (optimal latex, optimal lignin).

TABLE 5
Formulation D (EO1)

| Ingredient | Weight (%) |
|---|---|
| lignin | 10% |
| latex | 7% |
| glycerol | 20% |
| alkalizer | 0.5-2% |
| cellulose (MFC) | 40% |
| water | 21-22.5% |
| Total | 100.00% |

In other embodiments, the formulation comprises the components of Table 6 (high latex, optimal lignin, no additional water).

TABLE 6
Formulation E (EO2 + NCC)

| Ingredient | Weight (%) |
|---|---|
| lignin | 10% |
| latex | 17% |
| glycerol | 20% |
| alkalizer | 1.5% |
| cellulose (MFC) | 40% |
| cellulose (NCC) | 11.5% |
| water | 0% |
| Total | 100.00% |

In other embodiments, the formulation comprises the components of Table 7 (high latex, optimal lignin and no glycerol).

TABLE 7
Formulation F (EO2P)

| Ingredient | Weight (%) |
|---|---|
| lignin | 10-15% |
| latex | 17% |
| glycerol | 0% |
| alkalizer | 1.5% |
| cellulose (MFC) | 40% |
| water | 16.5-21.5% |
| Total | 100.00% |

In other embodiments, the formulation comprises the components of Table 8 (hardwood lignin, glycerol containing).

TABLE 8
Formulation G (EO2 E1)

| Ingredient | Weight (%) |
|---|---|
| lignin | 10% |
| latex | 17% |
| glycerol | 20% |
| alkalizer | 1.5% |
| cellulose (MFC) | 40% |
| water | 11.5% |
| Total | 100.00% |

In other embodiments, the formulation comprises the components of Table 9 (hardwood lignin, no glycerol).

TABLE 9
Formulation H (EO5 E1 or EO2 E1P)

| Ingredient | Weight (%) |
|---|---|
| lignin | 10% |
| latex | 17% |
| glycerol | 0.0% |
| alkalizer | 1.5% |
| cellulose (MFC) | 40% |
| water | 31.5% |
| Total | 100.00% |

In other embodiments, the formulation comprises the components of Table 10 (softwood lignin, contains glycerol).

TABLE 10
Formulation I (EO2 C2)

| Ingredient | Weight (%) |
|---|---|
| lignin | 15% |
| latex | 17% |
| glycerol | 20% |
| alkalizer | 1.5% |
| cellulose (MFC) | 40% |
| water | 6.5% |
| Total | 100.00% |

In other embodiments, the formulation comprises the components of Table 11 (softwood lignin, no glycerol).

TABLE 11
Formulation J (EO5 C2 or EO2 C2P)

| Ingredient | Weight (%) |
|---|---|
| lignin | 15% |
| latex | 17% |
| glycerol | 0.0% |
| alkalizer | 1.5% |
| cellulose (MFC) | 40% |
| water | 26.5% |
| Total | 100.00% |

In other embodiments, the formulation further comprises one or more additional ingredients such as a pigment or a viscosity modifier.

### Methods of Preparation

Embodiments also include methods of forming a coating on a surface of a substrate such as paper or pulp. The method includes steps of (a) forming a coating solution by dissolving a lignin, cellulose and/or latex in an alkaline or mildly acidic solution (pH of 6.0 to 11), (b) applying the coating solution onto the surface of the substrate and (c) exposing the coated substrate to a heat and/or acid treatment.

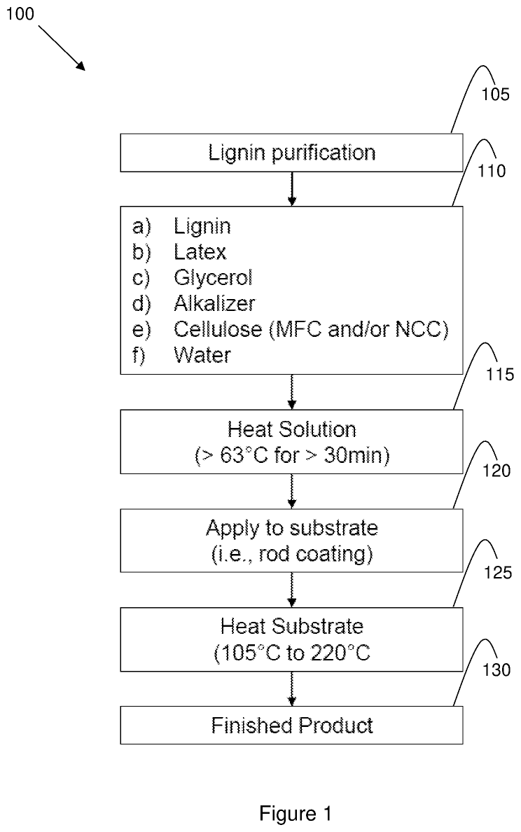

FIG. 1 lists the steps in a method 100 of preparing a coating on a substrate to produce a product such as biodegradable packaging. In the first step 105, lignin is purified from a source such as agricultural waste, annual fibres, biorefinery, nutshell residue, leaf litter or wood pulp. The components can be blended/mixed 110 and then heated 115 to above 63° C., for greater than 30 minutes, under either sealed (i.e., lab scale) or reflux (i.e., full-scale) conditions to limit evaporative loss of the alkalizer. The heating step aids solubility of the lignin and can also function as a Pickering emulsion for the other components such as latex (if present). The heat step can also denature allergen causing proteins from the natural latex thus mimicking pasteurization. While warm, the formulation can be sieved via a sock filter (600 μm-0.36 mm) with limited/trivial fines expected. Upon cooling, the formulation is ready to be applied to a substrate.

The formulation can be applied to a substrate 120 such as paper or pulp. Rod coating can be used to produce a typical board for a corrugated box. A wound rod is used to meter on the coating at a desired weight. This is typically 5 to 15% dry pickup of the object being coated (e.g., 200 GSM Kraft, between 10-30 GSM dry coating will offer favourable results). Lower coating weights can be used based on exact compositions (e.g., 1% to 5% dry pickup). Similarly, higher coatings weights can be used based on application and desired physical characteristics.

The biobased coating can be applied so that it has a desired thickness. The thickness can be adjusted by using different coating methods. For example, common techniques include rod coating, offset printing, flexographic printing, size press or by spray (HVLP, Airless, air knife) coating or dip. One skilled in the art will recognize that other coating techniques can be used, including, gravure coating, reverse roll coating, knife-over-roll coating (i.e., “gap coating”), metering rod (i.e., Meyer Rod) coating, slot die (i.e., slot extrusion) coating, immersion (dip) coating, curtain coating and air knife coating. Alternatively, multiple layers of the biobased coating can be applied.

According to some embodiments, the thickness of the coating is from 1-5 microns, from 1-10 microns, from 1-25 microns, from 1-50 microns, from 10-20 microns, from 10-30 microns, from 20-50 microns, from 30-60 microns, from 1-75 microns, from 1-100 microns or from 25-50 microns.

According to some embodiments, the thickness of the coating is about 5 microns, about 10 microns, about 15 microns, about 20 microns, about 30 microns or more.

According to some embodiments, the coating is less than 10 microns, less than 20 microns, less than 30 microns, less than 40 microns, less than 50 microns or less than 60 microns.

Thereafter, the coated substrate is subjected to a heat treatment 125 at a temperature of between 105° C. to 220° C. Preferably, the temperature is between 115° C. to 180° C.

In some embodiments, the heat treatment is at about 180° C. This step bestows water resistant characteristics to the finished product 130. Alternatively, an acid treatment can be used with the to produce the finished product.

### Methods of Use

Biodegradable materials are materials that can safely and effectively break down or decompose, in the presence of oxygen and natural organisms like bacteria, to natural elements. Composting is a good example of biodegradation. Accordingly, the applicant proposes the use of the biobased coating described herein as a replacement for products that typically end up in landfills.

Although the materials and methods are described for use in containers for packaging, storing and shipping consumer products, the use is not so limited. Proposed uses include agricultural mulch films, weed matting, plant protection (wind), pot plant replacements, void lining or insulation for construction, pallet liners onto existing pallet solutions, replacing more space consuming single face cushioning, or replacing the pallet with a paper based alternative, formwork panels, corrosion control on metal surfaces (i.e., as a sacrificial layer), automotive and/or industrial part packing (sacrificial layer), strength enhancement of virgin Kraft paper, testliner or recycled material when applied via, for example, a size press, moulded paper products for storage of liquids including paint, flexible pouches, biodegradable electronics, paper bags, waste product valorisation, moulded bagasse, fruit and/or vegetable covering (e.g., banana covers during growing), paper injection moulding, artificial leather coatings, leather coatings, wood products, interior paints and coatings, exterior paints and coatings, other plastic or biocoating and bio-based coatings.

The biobased coating can also be formulated as a single layered or multilayered biodegradable sheet. Biodegradable sheets are useful, for example, in packaging a material for direct food contact, indirect food contact and non-food contact applications, including liquid or semi-solid material such as food stuff or a liquid including biobased materials for sanitation. Other uses include “honeycomb” for construction material (walls/chairs/doors), erosion control (expanded honeycomb webbing filled with soil), coating of seeds (natural biocide and protection for water), carrier for fungistatic/bactastic or algastatic non-leaching material, as carrier for nitrogen (e.g., urea) for slow-release fertilizer. The coating can be used for any application that can benefit from an increase of water resistance and/or increase of strength. Further, the coating is useful as a sacrificial layer for and can be applied to a substrate at any temperature, including room temperature.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

### EXAMPLES

The following non-limiting examples are provided for illustrative purposes only in order to facilitate a more complete understanding of representative embodiments now contemplated. These examples are intended to be a mere subset of all possible contexts in which the components of the formulation may be combined. Thus, these examples should not be construed to limit any of the embodiments described in the present specification, including those pertaining to the type and amounts of components of the formulation and/or methods and uses thereof.

### Example 1—Coating Paper for Water Resistance and Improved Structural Integrity

Consumer packaging material can be created using recycled paper as a starting material. In this example, boxes are created by using the methods described herein to coat sheets of paper with a lignin/cellulose and/or latex mixture. The coating provides strength, structural integrity and/or water resistance to the paper. The boxes can be used for storage, shipping and for aesthetic purposes.

The following ingredients are obtained from commercial sources: lignin (97% active), latex (61% active), ammonia (25% active), MFC (2% active) and glycerol (100%). The ingredients are combined to achieve the weight percentages (i.e., active weight percentages) described in Table 2. The components are then blended/mixed to form a coating solution. The coating solution is then heated to above 63° C., for longer than 30 minutes under either sealed (lab scale) or reflux (full-scale) conditions to limit evaporative loss of the alkalizer. The heating step aids solubility of the lignin, and possibly functions as a Pickering emulsion for the other components, such as latex. Heating can also denature any allergen causing proteins from the natural latex, thus mimicking a typical pasteurization practice. This helps ensure safety and consumer comfort/safety. While warm, the formulation can be sieved via a sock filter (e.g., 600 μm-0.36 mm) with minimal loss of the coating. On cooling, the coating formulation is ready for application to a substrate.

The coating formulation is then applied to a substrate, for example, paper or pulp. For typical board used to make corrugated boxes, this is by rod coating, where a wound rod is used to meter on the coating at a desired weight. This is typically 5 to 15% dry pickup of the object being coated (i.e., 200 GSM Kraft, between 10 to 30 GSM dry coating will offer positive results) but may extend to lower coating weights based on exact compositions (e.g., 1 to 5% dry pickup), or higher coatings weights based on application, where a coating may function in a sacrificial manner for some other process.

After the coating formulation is applied, the coating is exposed to a heat treatment, between 105 to 220° C., (preferably 120 to 180° C.). In this example, it is heat treated at 180° C. for 5 minutes (labscale) or 20 seconds (fullscale) as the duration is linked to the nature of the heating method used and speed at which surface can reach target temperature. This bestows water resistance to the coated paper and allows for its use in consumer products.

The product is a sheet of paper or pulp that is coated with a thin layer of lignin/cellulose and/or latex. The coating can provide strength, structural integrity and/or water resistance. Ingredients such as antimicrobial agents, pigments and scents can be added depending on the intended use. In this example, the sheet is either directly folded into the shape of a box or corrugated first and then converted into the shape of a box. The boxes can be used for storage, shipping and for aesthetic purposes.

### Example 2—Preparation of Compostable Food Container

In this example, a box is prepared for food packaging. Sheets of recycled paper are used as a substrate. The sheets can be pre-cut into templates. The sheets are treated by rod coating with the biobased coating described above. After the heating step, the sheets can be stored and/or shipped to the user. The user can fold them into boxes. The size/shape of the boxes can be determined by the intended use.

Benefits include improved strength, structural integrity and water resistance. Further, the boxes maintain high rates of biodegradation. The prepared box should provide a food packaging shelf life sufficient to preserve its food content and might even extend the shelf life. For a dry food content, the shelf life may be extended to twelve months. Provided the degradable packaging is exposed to an ambient humidity and room temperature, its barrier properties and mechanical properties should not significantly decrease within this 12-month period (e.g., within 10% of its original value).

### Example 3—Use of Biocoating as a Sacrificial Layer

A sacrificial layer can be used as a protective cover to prevent a substrate from corrosion or rusting. In this example, the biocoating is applied as a sacrificial layer to a metal substrate (e.g., iron, gold, silver, copper, and aluminium or alloy such as brass or steel). In this regard, the biocoating presents an attractive alternative to conventional petroleum-based sacrificial layers, which often require acid for their removal.

As described above, the components of Table 2 are blended/mixed together to form a coating solution. The coating solution is then heated and sieved through a sock filter. Upon cooling, the coating formulation is applied to the metal substrate. The biocoating offers several benefits over conventional coatings. For example, it can be applied at relatively low temperatures. It can also include relatively high latex concentrations (e.g., above 5% w/w) unlike conventional formulations.

### Example 4—Comparison of Coating Formulations

In the next example, physical characteristics of different formulations of the biocoating were studied. Specifically, four different lignin-based formulations were generated for use in the following experiments:
Formulation A (EO2) (high latex, optimal lignin composition)
Formulation B (EO3) (optimal latex, low lignin composition).
Formulation C (EO4) (no latex, optimal lignin composition).
Formulation D (EO1) (optimal latex, optimal lignin composition)

### Formulation A (EO2)

The components described above (Table 2) were combined in an ambient reactor. For each study, the size of the reactor is preferably at least twice the expected volume to allow space for foaming. The formulation was heated to above 63° C. for 30 minutes. Foaming may be present and can be contained with common defoaming solutions and methods in the art such (e.g., addition of aerosolized ethanol). The formulation was passed through a sock filter (i.e., 0.36 mm screen) with nil or negligible loss of product. Upon cooling the final product is ready for application to a substrate.

As described above, a Cobb moisture test is a method of determining the water absorptiveness of substrate such as a sized paper/board, including corrugated fibreboard, under standard conditions. A higher Cobb value indicates that a substrate absorbs a higher volume of water. The test involves placing a dry test piece of the substrate under a cylinder. Next, water (100 ml) is poured onto the substrate for a specified period of time. Then, a test piece on standardized blotting paper is placed on the substrate. Finally, a second piece of blotting paper is placed on the test piece and a roller is used to remove excess water. The test sample is weighed before and after this procedure which gives the absorption rate. The result is usually provided in grams per square meter (g/m²) as per the standard method. In this example, the coating application was Rod 36DW on a drawdown coater for annealing temperature 180° C. All paper used in the experiments was preconditioned by heating at 39° C. prior to coating. The duration of the coated samples within the oven (at lab scale) was five minutes but at full scale will be faster, with duration linked to the nature of the heat used (speed of surface reaching target condition).

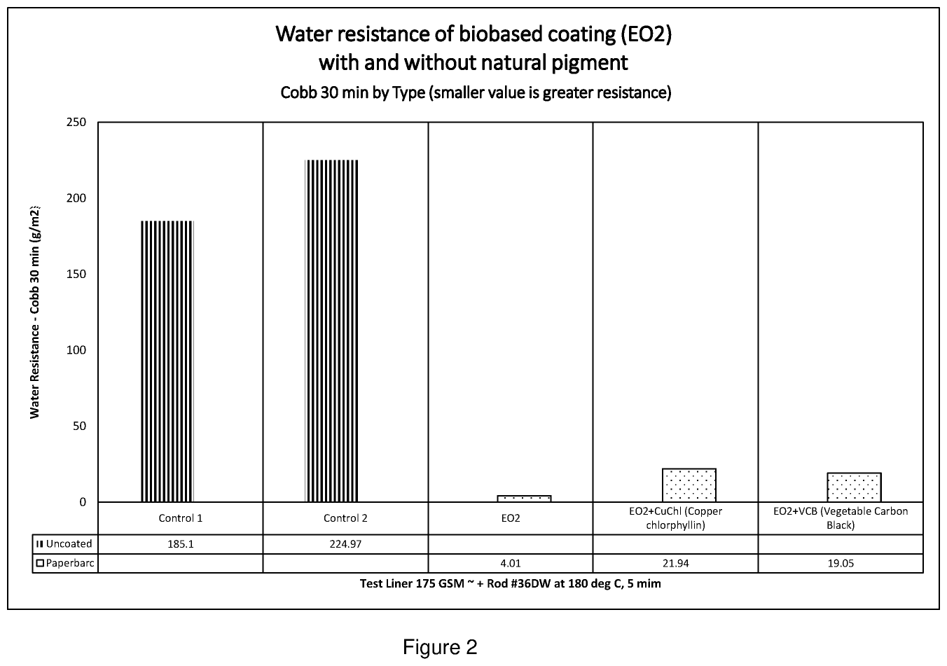

FIG. 2 is a graph showing the Cobb values of coating produced from different formulations on test liner, including natural pigments. In this study, two control samples of uncoated paperboard were used. The control samples absorbed high volumes of water compared to the treated substrate as shown with Cobb scores of approximately 180 g/m² and 220 g/m², respectively.

The substrate coated with the biobased coating (Formulation A/EO2) presented a Cobb score of below 5 g/m². Copper chlorophyllin (CuChl) is a bright green mixture derived from natural chlorophyll that can be used as a pigment. Similarly, vegetable carbon is a powder with colour shades range from grey to black. The addition of pigment led to a modest increase (e.g., about 20 g/m²) in Cobb scores.

In the next study, different coating methods were studied. Specifically, Cobb values were compared from samples that were prepared using activation temperatures from 120° C. to 200° C. using seven different coating weights (approx. 3.1%, 4.7%, 5.9%, 6.7%, 10.2%, 14.1% and 15.7% dry pickup by Rod #8, #12, #15, #17DW, #26DW, #36DW and 40 respectively, where DW=double wound).

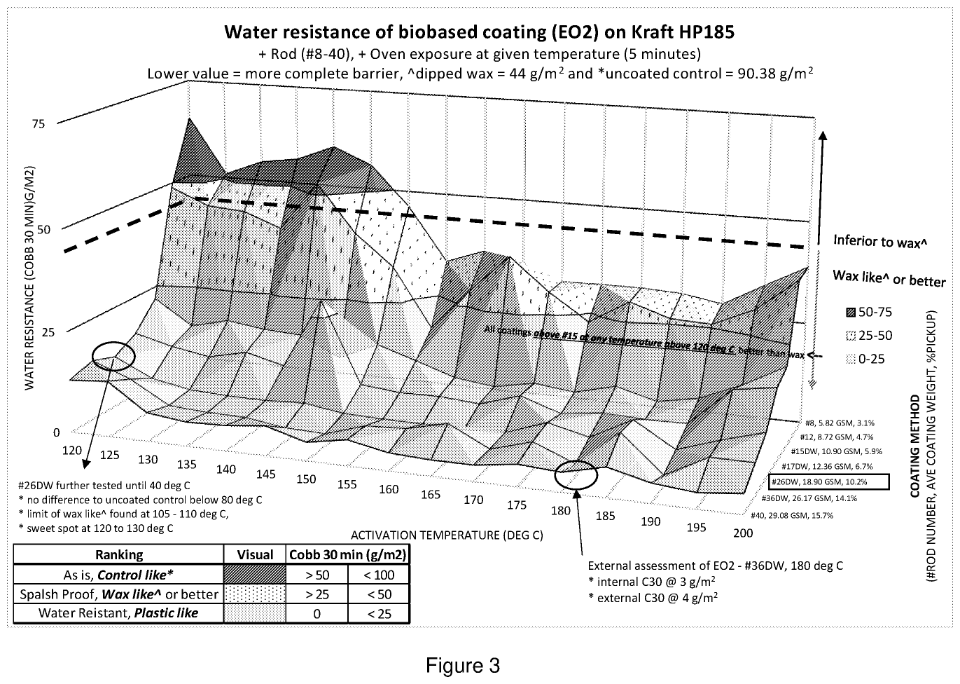

FIG. 3 is a graph showing the water resistance (i.e., Cobb values) of coating weight for each sample. The seven different coating methods are represented on the base of the graph (z-axis). For example, Rod #15DW had a coating weight of 18.90 GSM (g/m²) and 5.9% dry pickup. A control sample (i.e., uncoated substrate) presented a Cobb value of 90.38 g/m² (not shown). The dashed line indicates a Cobb value of wax (44 g/m²). Values below the dashed line indicated Cobb values lower than a substrate with a wax coating.

All coatings above Rod #15 (i.e., #17, #26, #36 and #40) at any temperature tested (120° C. to 200° C.) performed better than a comparative industry standard coating wax (44 g/m²) or uncoated control (90.38 g/m²). Coatings weights below Rod #15 (i.e., #8 and #12) at temperatures above 150° C. were also found to be superior to wax or uncoated control. Coatings below Rod #15 at temperatures below 150° C. were superior to the uncoated control but not as effective as wax. A coating weight using Rod #26DW (10.2% dry pickup) led to the lowest Cobb values. As shown on the graph, the ideal temperature for application is between 120° C. and 130° C.

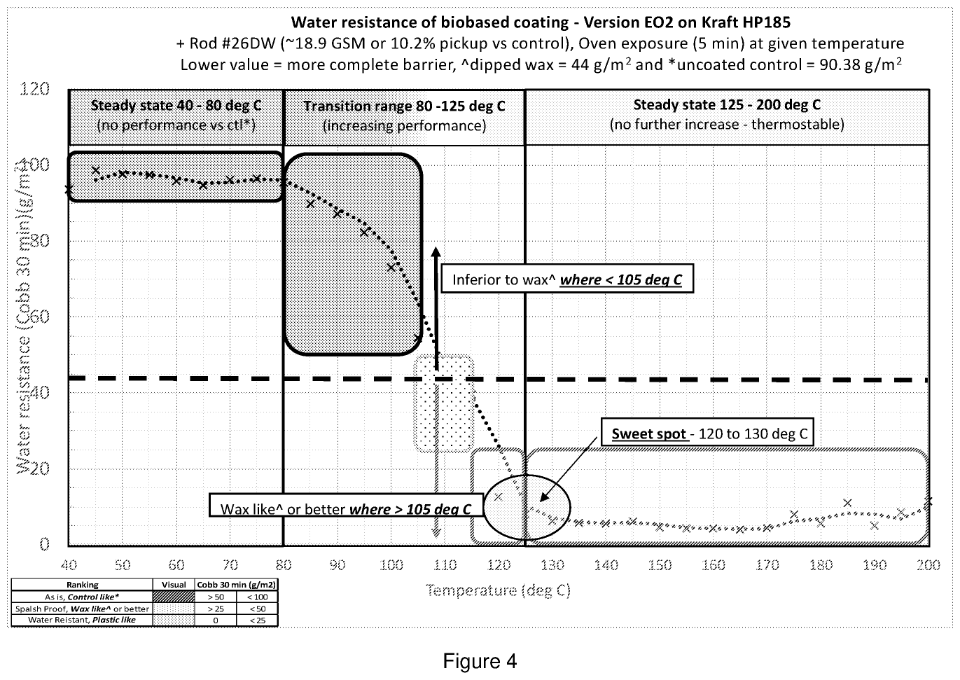

FIG. 4 is a graph showing the water resistance of coating when produced at temperatures from 40° C. to 200° C. using Rod #26DW only and identifies steady states and transition ranges. The Cobb values improved as the temperature increased above 80° C., with a coating that was “wax like” or better above 105° C. A leveling of performance was observed at about 125° C. Coating was thermostable across all ranges tested past this point (up to 200° C.).

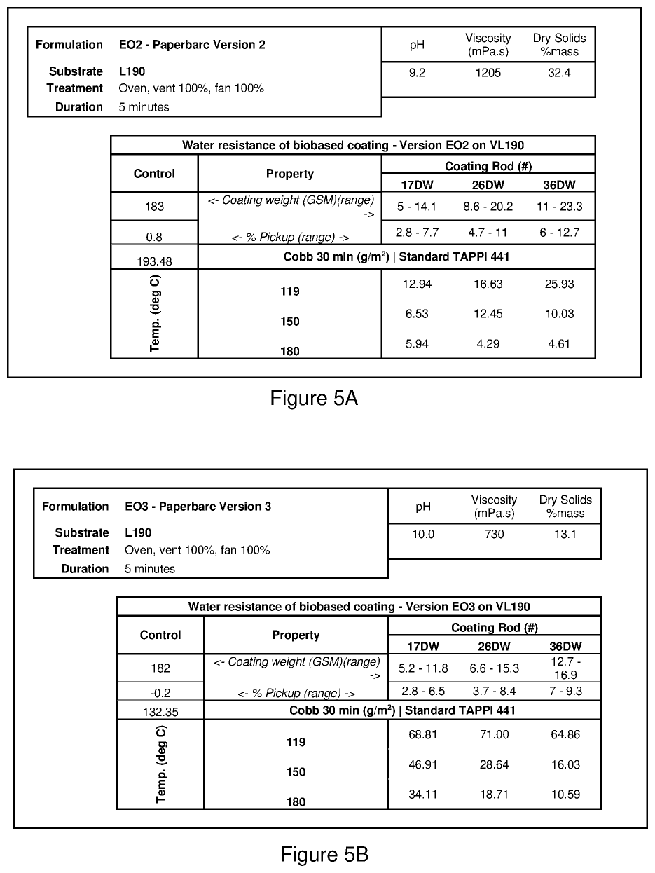

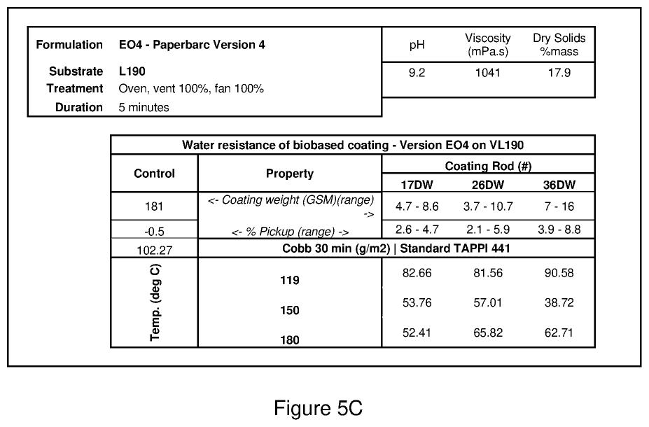

FIGS. 5A, 5B and 5C are tables with data on Formulation A (EO2), Formulation B (EO3), and Formulation C (EO4). The coating weight and Cobb values of the coating on recycled paper at three different temperatures (119° C., 150° C. and 180° C.) are indicated. The pH, Viscosity (mPa·s) and Dry Solids (% mass) of each formulation are also included.

Formulation A (EO2) had the highest viscosity (1205 mPa·s). The lowest Cobb values were achieved at 180° C., but all conditions tested were superior to wax and acceptable including lowest thermal (119° C.) and coating (#17DW) conditions. Similarly, Formulation B (EO3) had low Cobb values when applied at 150-180° C. Higher Cobb values were observed with Formulation C (EO4). However, the lowest Cobb values were achieved at 150° C.

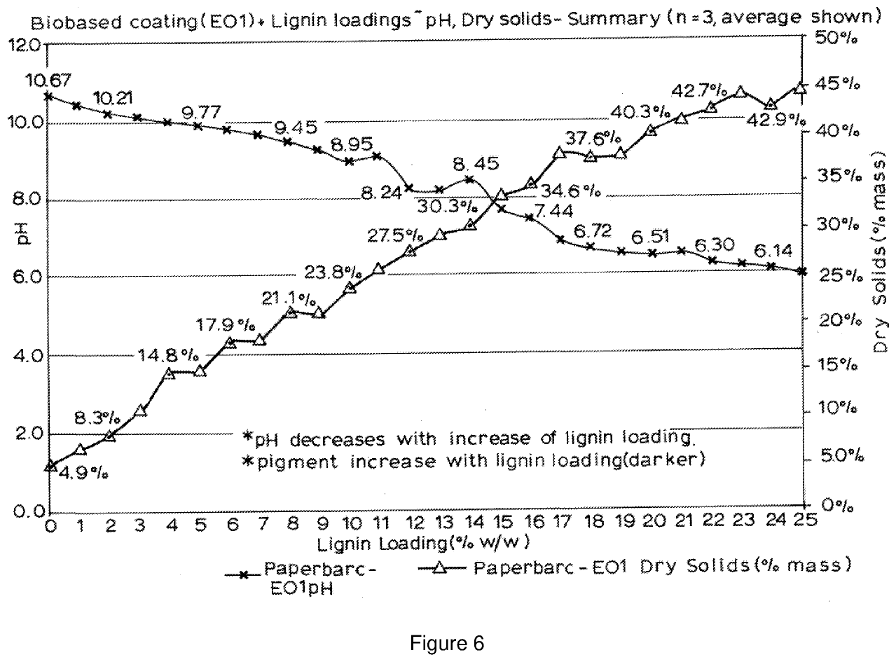

In the next study, lignin loading was compared with different pH values using the coating of Formulation D (EO1). As shown in FIG. 6, the pH decreased as the lignin loading increased. A pigment increase with lignin loading was observed and indicated a lower lignin could allow better pigmentation.

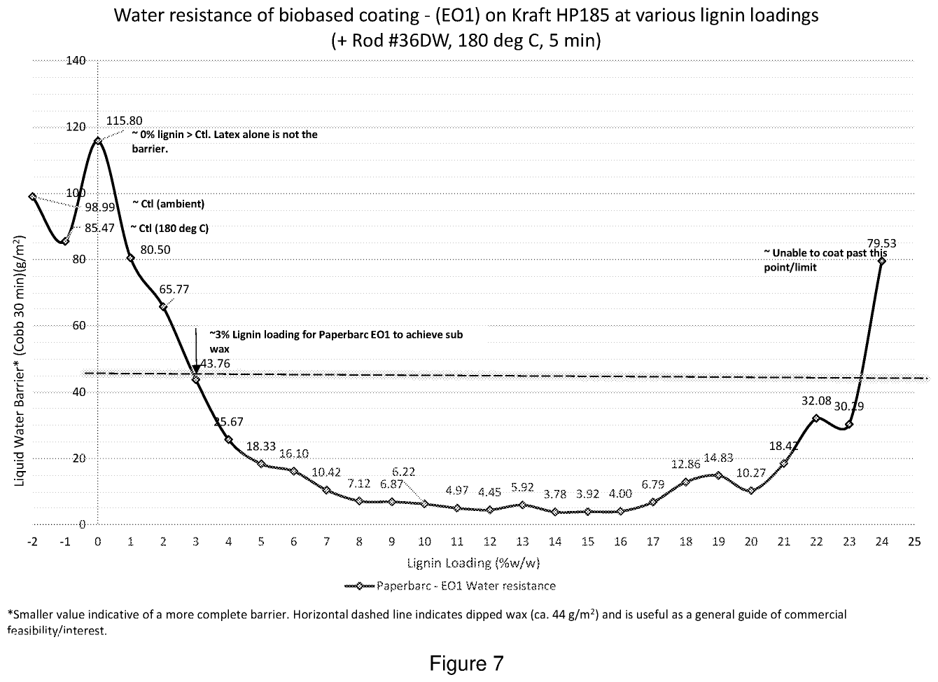

In the next study, water resistance was compared at various levels of lignin loading (% w/w) using the coating of Formulation D (EO1). FIG. 7 is a graph that compares Cobb values at lignin loadings from 0 to 25% w/w using Formulation D (EO1). As noted above, a lower value indicates a stronger barrier to water penetration. The horizontal dashed line indicates the Cobb value of dipped wax (ca. 44 g/m²) which is useful as a general guide of commercial feasibility/interest. Thus, useful loading is observed below the dashed line (i.e., between 3% and 23% w/w) and the ideal loading is between about 8% and 17% w/w (where Cobb values are below 10 g/m², and approach “plastic like” performance).

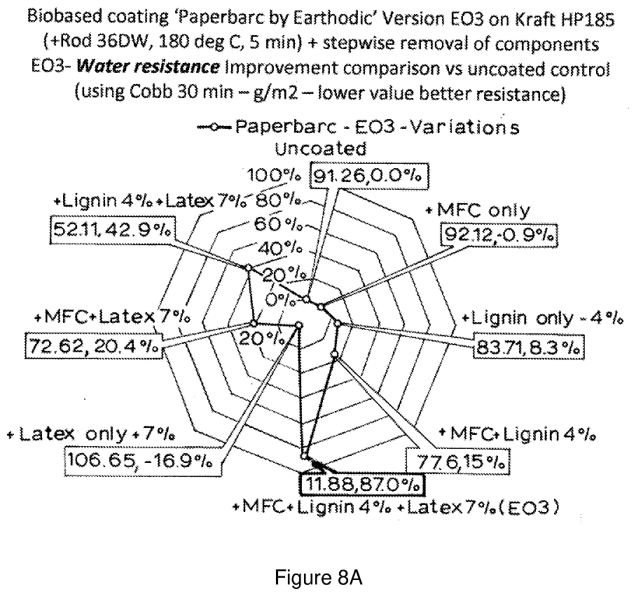

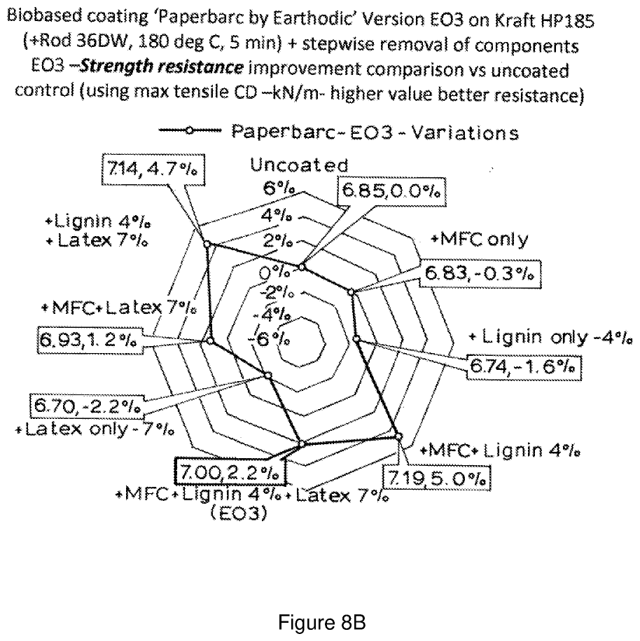

FIG. 8A is a graph showing the water resistance and percent change (versus uncoated control) of coating using Formulation B (EO3) on Kraft paper with stepwise removal of components. Using uncoated substrate, a Cobb value of 91.26 was observed. This value was used to show a percent change in each of the other samples: (1) MFC only, (2) lignin only, (3) MFC+lignin, (4) MFC+lignin+latex, (5) latex only, (6) MFC+latex and (7) lignin+latex. The results demonstrate that in Formulation B (EO3) produced a Cobb value of 11.88 which is 87% lower than that of the control. Further, all three ingredients (MFC, 4% lignin and 7% latex) are essential to achieve this value.

Similarly, FIG. 8B is a graph showing the strength resistance (versus uncoated control) of coating using Formulation B (EO3) on Kraft paper with stepwise removal of components. Using uncoated substrate, a tensile strength value of 6.85 was observed. This value was used to show a percent change in each of the other samples: (1) MFC only, (2) lignin only, (3) MFC+lignin, (4) MFC+lignin+latex, (5) latex only, (6) MFC+latex and (7) lignin+latex. The results demonstrate that in Formulation B (EO3) had a tensile strength value of 7.00 which is 2.2% higher than that of the control. Further, all three ingredients (MFC, 4% lignin and 7% latex) are essential to achieve this value.

In particular, it can be seen that while coatings containing lignin, latex or MFC yielded an overall strength decrease, compared to uncoated controls, the addition of MFC and latex adds 1.2% strength and the inclusion of lignin (here at 4% w/w) adds a further 1% strength. This indicates the lignin is not the major strength enhancing agent but is a contributing factor. Although (+lignin 4%, +latex 7%) series yielded positive water resistance and strength improvement, without cellulose (here MFC) the surface was sticky with rapid blocking indicating latex loading is too high.

In embodiments, application of the biobased coating provides a substrate that is biodegradable. In comparison to wax (or other conventional coatings), the rate of biodegradation can be increased by at least 95%. In embodiments, the rate of biodegradation can be increased by at least 90%, by at least 80%, by at least 70%, by at least 60%, by at least 50% or by at least 40%. In comparison to wax (or other conventional coatings), the rate of biodegradation can be increased by about 95%. In embodiments, the rate of biodegradation can be increased by about 90%, by about 80%, by about 70%, by about 60%, by about 50% or by about 40%.

In embodiments, application of the biobased coating decreases the cobb value of a substrate material by at least 90%. In embodiments, the biobased coating decreases the cobb value by at least 90%, by at least 80%, by at least 70%, by at least 60%, by at least 50% or by at least 40%. In comparison to wax (or other conventional coatings), the cobb value of a substrate material is decreased by about 90%. In embodiments, the rate cobb value is decreased by about 90%, by about 80%, by about 70%, by about 60%, by about 50% or by about 40%.

According to some embodiments, the shelf-life of the substrate treated with the biobased coating is extended due to the presence of the coating, which has a degradation time of up to 24 months; therefore, the final composition can be tailored to have a degradation time of from a few weeks and up to 24 months, depending on the amount (weight or thickness) of the biobased coating and application conditions (temperature).

### Example 5—Dilution Studies

In this example, the physical characteristics of a diluted Formulation G (EO2 E1) of the biocoating were studied.

Specifically, 10 dilution variants of Formulation G (EO2 E1) were prepared ranging in dilution with water from 0-90% together with two controls.

The components described above (Table 8) were combined in an ambient reactor. For each study, the size of the reactor is preferably at least twice the expected volume to allow space for foaming. The formulation was heated to above 63° C. for 30 minutes. Foaming may be present and can be contained with common defoaming solutions and methods in the art such (e.g., addition of aerosolized ethanol). The formulation was passed through a sock filter (i.e., 0.36 mm screen) with no or negligible loss of product. Upon cooling the final product is ready for application to a substrate.

As described above, a Cobb moisture test is a method of determining the water absorptiveness of substrate such as a sized paper/board, including corrugated fibreboard, under standard conditions. A higher Cobb value indicates that a substrate absorbs a higher volume of water. The test involves placing a dry test piece of the substrate under a cylinder. Next, water (100 ml) is poured onto the substrate for a specified period of time. Then, a test piece on standardized blotting paper is placed on the substrate. Finally, a second piece of blotting paper is placed on the test piece and a roller is used to remove excess water. The test sample is weighed before and after this procedure which gives the absorption rate. The result is usually provided in grams per square meter (g/m²) as per the standard method. In this example, the coating application was Rod 36DW on a drawdown coater for annealing temperature 180° C. All paper used in the experiments was preconditioned by heating at 39° C. prior to coating. The duration of the coated samples within the oven (at lab scale) was five minutes.

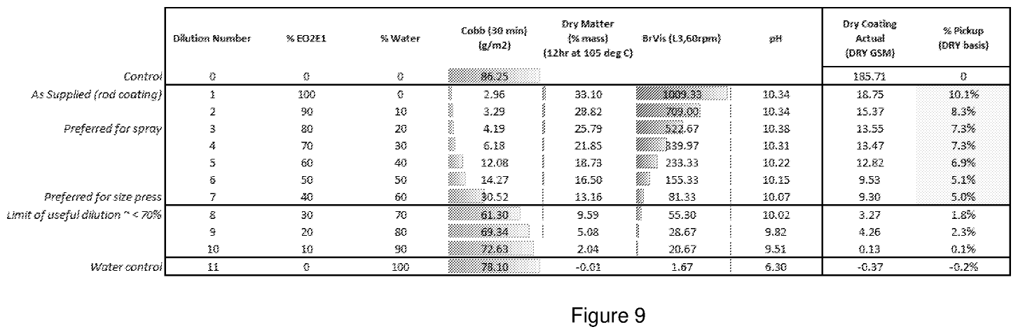

FIG. 9 is a table with data on the 10 dilution variants of Formulation G (EO2 E1) together with two controls. The coating weight and Cobb values of the coating on recycled paper at 105° C. are indicated. The BrVis (L3.60 rpm), pH, Viscosity (mPa·s) and Dry Solids (% mass) of each dilution variant are also included.

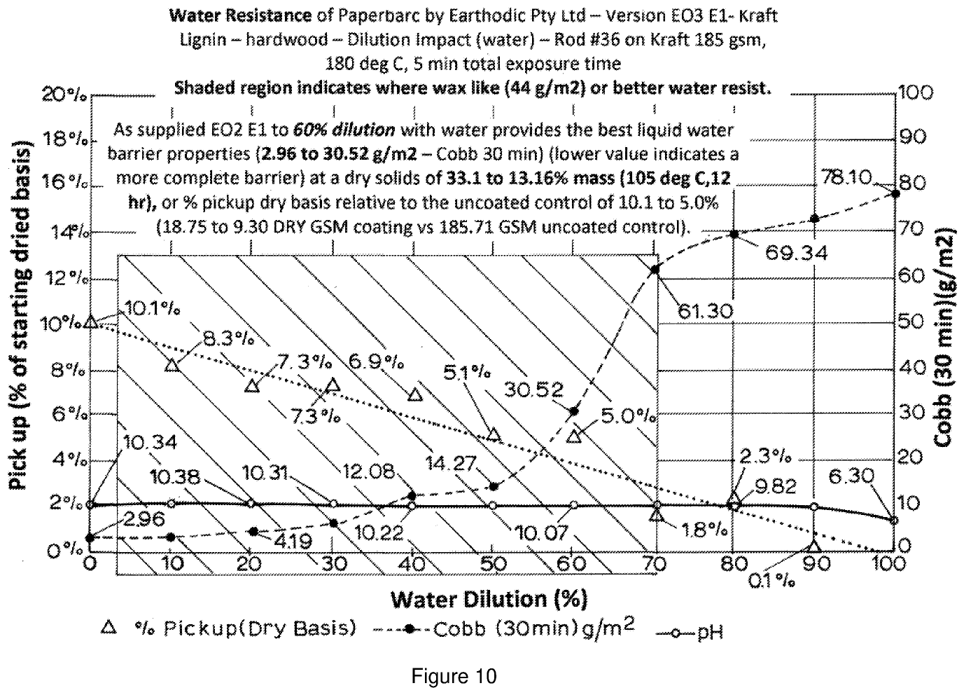

FIG. 10 is a graph showing the water resistance of the dilution variants of Formulation G (EO2 E1). The investigations were made to determine the useful limits of water dilution (% w/w) to as supplied Formulation G (EO2 E1). It was expected that around 20% dilution could be achieved due to typical drop in pH with water dilution. However, surprisingly the pH remained stable and allowed further dilution than expected to occur. Useful performance, as measured by the Cobb test (30 min) was discovered as far as 60% dilution with water (performance in the 30's) and this aligned with a dry solids of the formulation at 13.16% mass (105 deg C., 12 hr) or a pickup dry basis of 5.0%.

### Example 6—Surface Temperature Studies

In this example, the effects of heating temperature and duration relative to the physical characteristics of a variant of Formulation G (EO2 E1) of the biocoating were studied. In this variant, the lignin used was grass (EO2 L1)

Specifically, the physical characteristics of low and high coating weight variants of EO2 L1 were studied.

In this example, the coating application was Rod 17 (for low wet coating weight) and Rod 36 (for high wet coating weight) on a drawdown coater. Samples were then annealed in an oven at set temperatures (105° C., 119° C., 150° C. and 180° C.) for various durations (0.5 min, 1 min, 3 min, 5 min, 7 min and 10 min).

Once activated, samples were then liquid water barrier tested by a Cobb test for 30 min. As described above, a Cobb moisture test is a method of determining the water absorptiveness of a substrate such as a sized paper/board, including corrugated fibreboard, under standard conditions. A higher Cobb value indicates that a substrate absorbs a higher volume of water. The test involves placing a dry test piece of the substrate under a cylinder. Next, water (100 ml) is poured onto the substrate for 30 min. Then, a test piece on standardized blotting paper is placed on the substrate. Finally, a second piece of blotting paper is placed on the test piece and a roller is used to remove excess water. The test sample is weighed before and after this procedure which gives the absorption rate. The result is usually provided in grams per square meter (g/m²) as per the standard method.

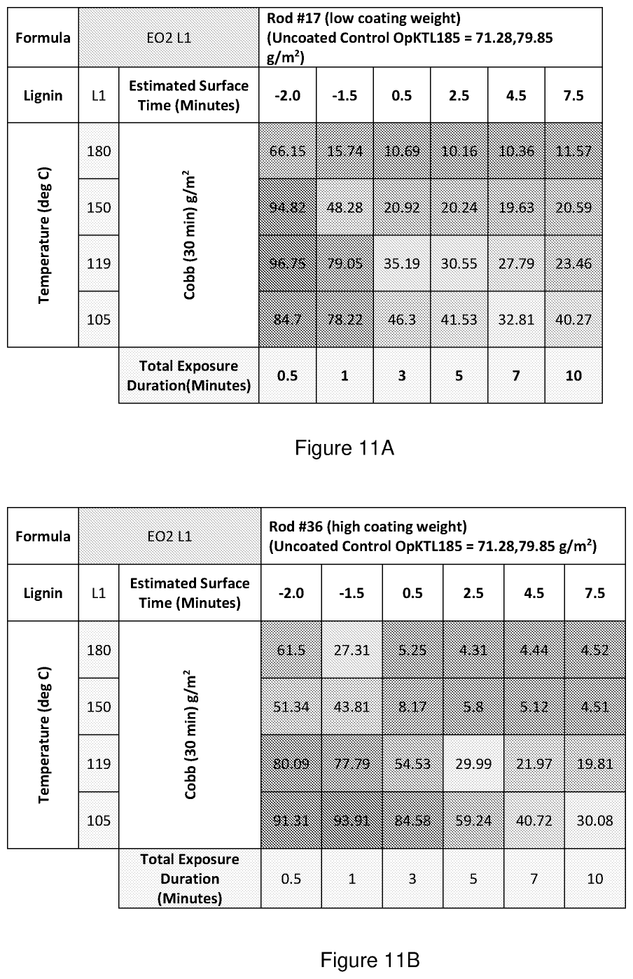

FIGS. 11A and 11B are tables with data on low and high coating weight variants of Formulation G (EO2 L1), respectively. The Cobb values of the coating on recycled paper at four different temperature (105° C., 119° C., 150° C. and) 180° and six different heating durations (0.5 min, 1 min, 3 mins, 5 mins, 7 mins and 10 mins) are indicated.

The investigations were made to determine an optimal heating duration, which was expected to be about 3 minutes (as this is the approximate time for a surface to reach a target temperature in a laboratory based testing ovens). Generally, the temperature was required for 3 minutes to achieve wax like and above performance. For 150° C. and 180° C., as low as 1 min may be used (flash) but no results were satisfactory at 0.5 minutes.

Further, the data demonstrates that once the surface reached the target temperature (˜2.5 mins in used laboratory ovens, but seconds in industry practise) the performance levels out, with limited improvement with the longer heating times. This indicates that reaching the surface target temperature is the critical aspect rather than heating duration.

### Example 7—Water Resistance and Strength Studies

In this example, the effects of lignin loading relative to the physical characteristics of a Formulation H (EO2 C2) of the biocoating were studied.

Specifically, 23 lignin % (w/w) variants of Formulation G (EO2 E1) were prepared ranging from 1% (w/w) to 23% (w/w) together with two controls and the physical characteristics of water resistance and strength relative to lignin loading % (w/w) were studied.

The components described above (Table 10) were varied according to lignin content and combined in an ambient reactor. For each study, the size of the reactor is preferably at least twice the expected volume to allow space for foaming. The formulation was heated to above 63° C. for 30 minutes. Foaming may be present and can be contained with common defoaming solutions and methods in the art such (e.g., addition of aerosolized ethanol). The formulation was passed through a sock filter (i.e., 0.36 mm screen) with no or negligible loss of product. Upon cooling the final product is ready for application to a substrate.

In this example, the coating application was Rod 36 on a drawdown coater. Samples were then annealed in an oven at a set temperature 180° C. for 5 mins. All paper used in the experiments was preconditioned by heating at 39° C. prior to coating

For the water resistance studies, a Cobb moisture test was performed as a method of determining the water absorptiveness of substrates such as a sized paper/board, including corrugated fibreboard, under standard conditions. A higher Cobb value indicates that a substrate absorbs a higher volume of water. The test involves placing a dry test piece of the substrate under a cylinder. Next, water (100 ml) is poured onto the substrate for a specified period of time. Then, a test piece on standardized blotting paper is placed on the substrate. Finally, a second piece of blotting paper is placed on the test piece and a roller is used to remove excess water. The test sample is weighed before and after this procedure which gives the absorption rate. The result is usually provided in grams per square meter (g/m²) as per the standard method.

A ring crush test (RCT) is a method of determining the ring crush resistance or strength of substrate such as a sized paper/board, including corrugated fibreboard, under standard conditions. A higher RCT value indicates that the substrate exhibits greater ring crush resistance or strength. The test involves placing a test piece of the substrate into a holder with a circular groove and determining the amount of force required to crush it. The result is usually provided in Newtons (N).

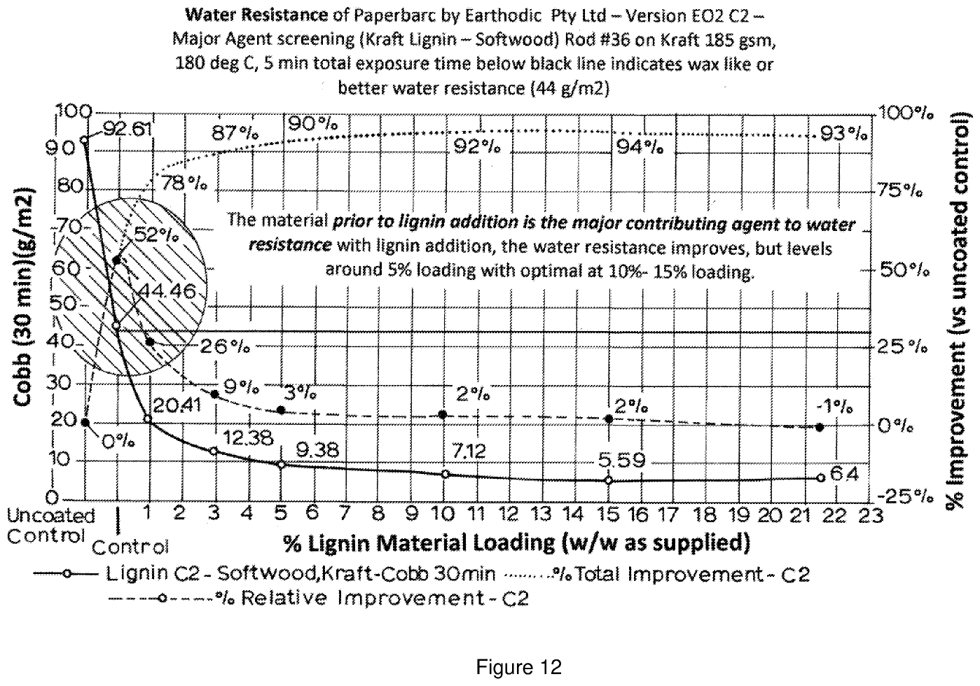

FIG. 12 is a graph showing the water resistance of the lignin loading % (w/w) variants of Formulation H (EO2 C2). With reference to the % relative improvement between loadings, the data demonstrates that while lignin contributes to water resistance, the components prior to lignin addition are the major water resistance contributing agents.

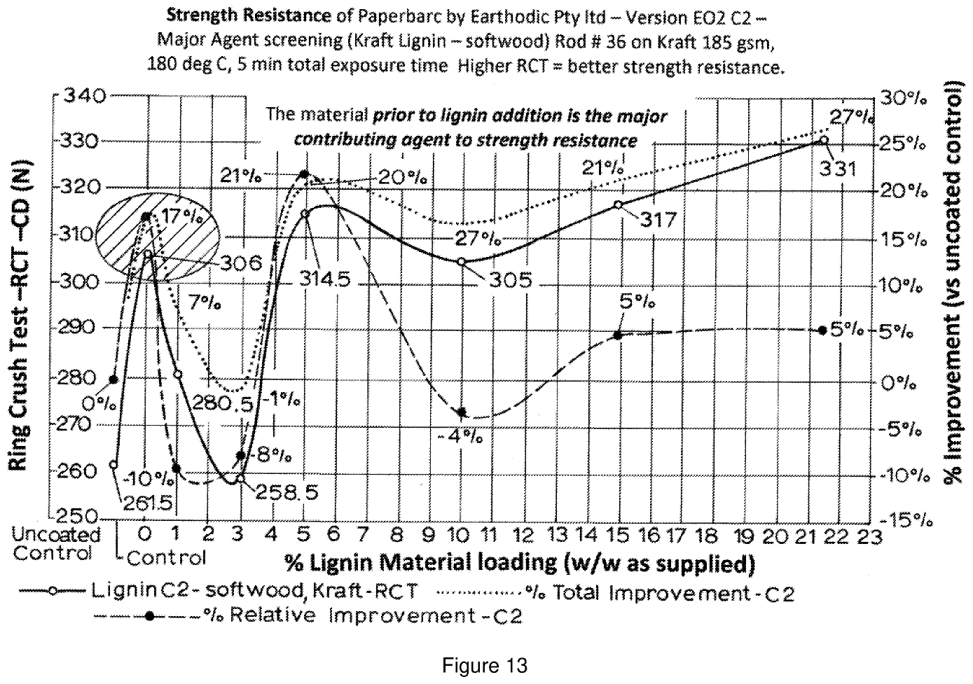

FIG. 13 is a graph showing strength of the lignin loading % (w/w) variants of Formulation H (EO2 C2). Again, reference to the % relative improvement between loadings, demonstrates that while lignin contributes to strength, the components prior to lignin addition are the major strength contributing agents.

### Example 8—Glycerol Studies

In this example, the effects of glycerol were studied relative to the physical characteristics of various biocoatings.

Specifically, the physical characteristics of biocoatings of Formula G (EO2 E1) and Formula H (EO5 E1) and Formula I (EO2 C2) and Formula J (EO5 C2) were compared.

The respective components described above (Tables 8-11) were combined in an ambient reactor. For each study, the size of the reactor is preferably at least twice the expected volume to allow space for foaming. The formulation was heated to above 63° C. for 30 minutes. Foaming may be present and can be contained with common defoaming solutions and methods in the art such (e.g., addition of aerosolized ethanol). The formulation was passed through a sock filter (i.e., 0.36 mm screen) with no or negligible loss of product. Upon cooling the final product is ready for application to a substrate.

In this example, the coating application was Rod 16 on a drawdown coater. Samples were then annealed in an oven at set temperatures of 130° C. and 180° C. for 5 mins. All paper used in the experiments was preconditioned by heating at 39° C. prior to coating

Once activated, samples were then liquid water barrier tested by a Cobb test for 30 min. As described above, a Cobb moisture test is a method of determining the water absorptiveness of substrate such as a sized paper/board, including corrugated fibreboard, under standard conditions. A higher Cobb value indicates that a substrate absorbs a higher volume of water. The test involves placing a dry test piece of the substrate under a cylinder. Next, water (100 ml) is poured onto the substrate for 30 min. Then, a test piece on standardized blotting paper is placed on the substrate. Finally, a second piece of blotting paper is placed on the test piece and a roller is used to remove excess water. The test sample is weighed before and after this procedure which gives the absorption rate. The result is usually provided in grams per square meter (g/m²) as per the standard method.

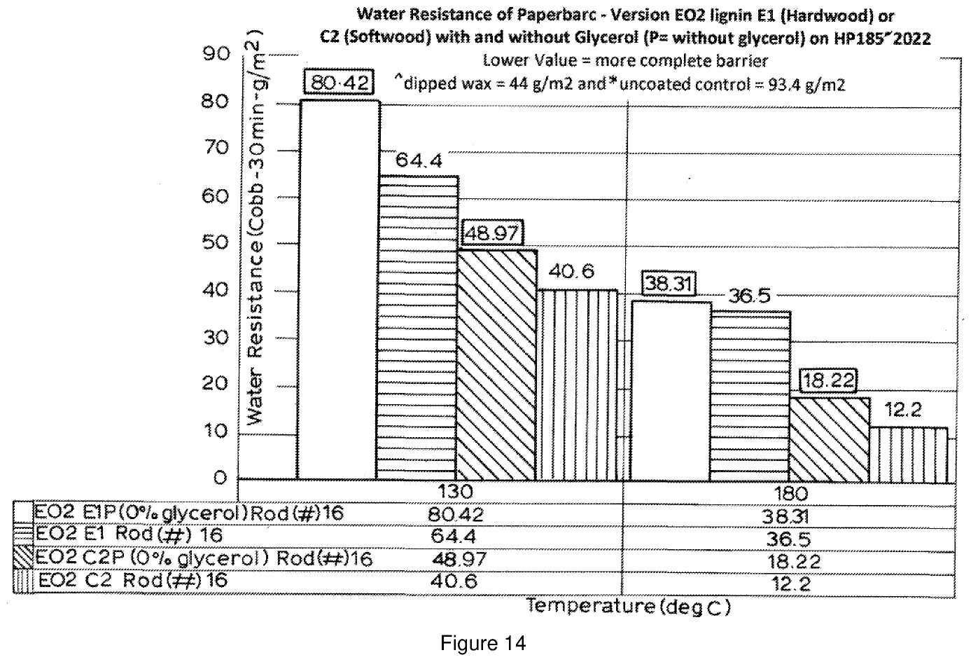

FIG. 14 is a graph showing the water resistance of EO2 E1 v EO5 E1 (EO2 E1P) and EO2 C2 v EO5 C2 (EO2 C2P) when annealed at 130° C. and 180° C.

Previous studies with lignin had shown that without glycerol, a more brittle lignin coating would form with little performance even at high annealing temperatures. Surprisingly, the results reveal that there are only minor differences in water resistivity between the formulations containing glycerol and those without at the respective annealing temperatures. The samples at the higher annealing temperature predictably exhibited better water resistivity.

### Example 9—Glycerol Loading Studies

In this example, the effects of glycerol loading relative to the physical characteristics of a Formulation G (EO2 E1) of the biocoating were studied.

Specifically, 6 variants of Formulation G (EO2 E1) ranging from 5% (w/w) to 31.5% (w/w) glycerol were prepared together with two controls and the physical characteristics of water resistance relative to glycerol loading % (w/w) were studied.

The components described above (Table 8) were varied according to glycerol content and combined in an ambient reactor. For each study, the size of the reactor is preferably at least twice the expected volume to allow space for foaming. The formulation was heated to above 63° C. for 30 minutes. Foaming may be present and can be contained with common defoaming solutions and methods in the art such (e.g., addition of aerosolized ethanol). The formulation was passed through a sock filter (i.e., 0.36 mm screen) with no or negligible loss of product. Upon cooling the final product is ready for application to a substrate.

In this example, the coating application was Rod 36 on a drawdown coater. Samples were then annealed in an oven at a set temperature 180° C. for 5 mins. All paper used in the experiments was preconditioned by heating at 39° C. prior to coating

For the water resistance studies, a Cobb moisture test was performed as a method of determining the water absorptiveness of substrate such as a sized paper/board, including corrugated fibreboard, under standard conditions. A higher Cobb value indicates that a substrate absorbs a higher volume of water. The test involves placing a dry test piece of the substrate under a cylinder. Next, water (100 ml) is poured onto the substrate for a specified period of time. Then, a test piece on standardized blotting paper is placed on the substrate. Finally, a second piece of blotting paper is placed on the test piece and a roller is used to remove excess water. The test sample is weighed before and after this procedure which gives the absorption rate. The result is usually provided in grams per square meter (g/m²) as per the standard method.

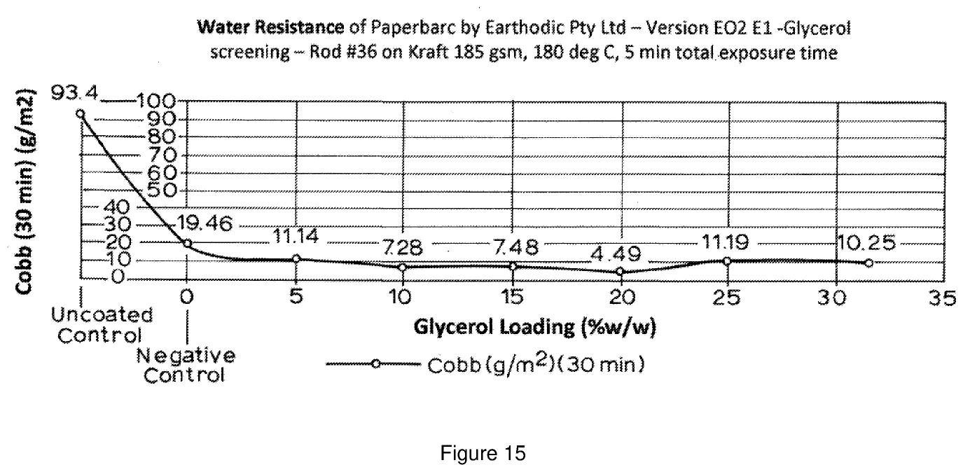

FIG. 15 is a graph showing the water resistance of the glycerol loading % (w/w) variants of Formulation G (EO2 E1). The data demonstrates that glycerol is not required but does have a moderate improvement with loading all the way from 5% (w/w) to max loading of 31.5% (w/w), and optimal at 20% (w/w). Surprisingly, the 0% (w/w) glycerol loading, included as a negative control, exhibit a Cobb value of 19.46 g/m², indicating that some water resistivity is possible without glycerol.

### Example 10—Xylose Loading

In this example, the effects of xylose loading relative to the physical characteristics of a variant of Formulation G (EO2 E1) of the biocoating were studied. In this variant, the lignin used was grass (EO2 L1).

Specifically, 5 variants of Formulation G (EO2 L1) ranging from 1% (w/w) to 10% (w/w) xylose were prepared together with two controls and the physical characteristic of strength relative to xylose loading % (w/w) were studied.

The components described above (Table 8) were varied according to lignin content and xylose loading and combined in an ambient reactor. For each study, the size of the reactor is preferably at least twice the expected volume to allow space for foaming. The formulation was heated to above 63° C. for 30 minutes. Foaming may be present and can be contained with common defoaming solutions and methods in the art such (e.g., addition of aerosolized ethanol). The formulation was passed through a sock filter (i.e., 0.36 mm screen) with no or negligible loss of product. Upon cooling the final product is ready for application to a substrate.

In this example, the coating application was Rod 36 on a drawdown coater. Samples were then annealed in an oven at a set temperature 180° C. for 5 mins. All paper used in the experiments was preconditioned by heating at 39° C. prior to coating

As previously mentioned, a ring crush test (RCT) is a method of determining the ring crush resistance or strength of substrate such as a sized paper/board, including corrugated fibreboard, under standard conditions. A higher RCT value indicates that the substrate exhibits greater ring crush resistance or strength. The test involves placing a test piece of the substrate into a holder with a circular groove and determining the amount of force required to crush it. The result is usually provided in Newtons (N).

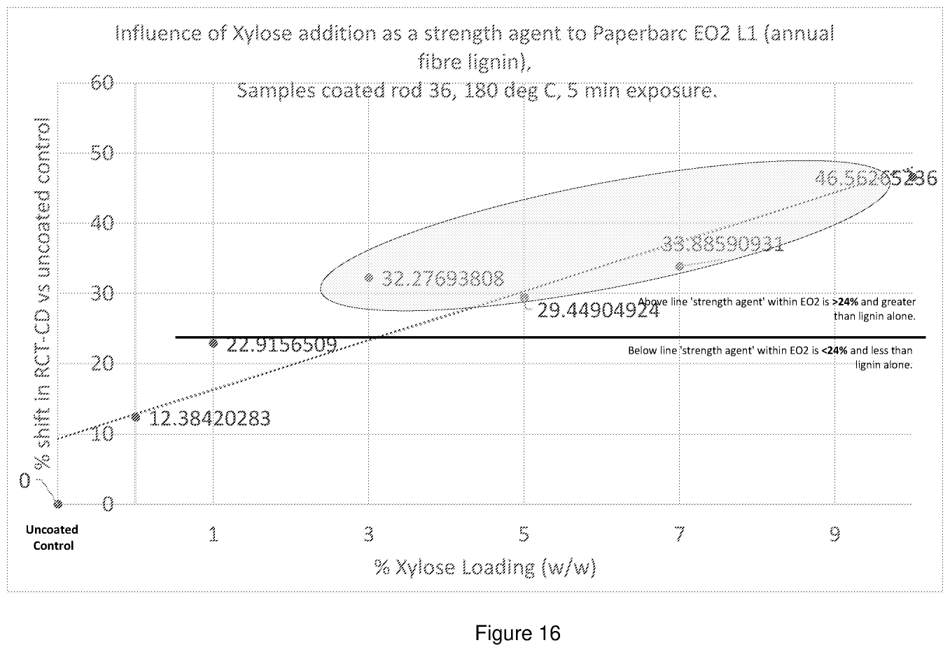

FIG. 16 is a graph showing % shift in strength relative to an uncoated control. The data demonstrates that a xylose addition adds a modest improvement to strength, as measurement by the RCT, and at level of 3% loading and above, has a % improvement vs the control twice that of non xylose containing controls, indicating it becomes the overall major strength agent within the formulation.

1. A biobased coating for a substrate, comprising:
(a) between about 0.1 to about 32% w/w lignin;
(b) between about 0.0 to about 20% w/w latex;
(c) between about 0.0 to about 40% w/w plasticizer; and
(d) between about 0.1 to about 70% w/w cellulose.

2. A biobased coating for a substrate, comprising:
(a) between about 0.1 to about 32% w/w lignin;
(b) between about 0.0 to about 40% w/w plasticizer; and
(c) between about 0.1 to about 70% w/w cellulose.

3. (canceled)

4. The biobased coating of claim 1, wherein the substrate further comprises one of paper, pulp, starch, mushroom (including mycelium), seaweed, corrugated cardboard, uncorrugated cardboard, recycled cardboard/paper, a fabric, concrete, and metal.

5. The biobased coating of claim 1, further including-comprising a pigment.

6. The biobased coating of claim 1, further comprising a viscosity modifier.

7. The biobased coating of claim 1, wherein the cellulose is one of microfibrillated cellulose (MFC) and nano crystalline cellulose (NCC).

8. The biobased coating of claim 1, wherein the plasticizer is at least one of glycerol, a sugar alcohol, and a polyol.

9. The biobased coating of claim 1, further comprising an alkalizer.

10. The biobased coating of claim 1, wherein the lignin is sourced from any one of plants, softwood, hardwood, grasses, jute, hemp, cotton, sugarcane, straw, grass, and nut residue.

11. The biobased coating of claim 1, wherein the cellulose is sourced from any one of cotton, hemp, flax, jute, algae, bacteria, and wood.

12. A method of forming a biobased coating on a surface of a substrate comprising:
(a) forming a biobased coating solution by dissolving a lignin and cellulose in an aqueous solution;
(b) heating the biobased coating solution;
(c) applying the biobased coating solution onto the surface of the substrate; and
(d) heating the substrate or treating the substrate with an acid to form the biobased coating on the substrate.

13. (canceled)

14. The method of claim 12, wherein the biobased coating solution comprises at least one of:
about 0.1 to about 25% w/w lignin and about 0.1 to about 70% w/w cellulose;
about 0.1 to about 40% w/w of a plasticizer; and
about 0.1 to about 20% w/w latex.

15-16. (canceled)

17. The method of claim 12, wherein the substrate is heated to form the biobased coating on the substrate at a temperature between 105° C. to 220° C.

18. (canceled)

19. The method of claim 12, wherein the substrate comprises any one of paper, pulp, starch, mushroom (including mycelium), seaweed, corrugated cardboard, uncorrugated cardboard, recycled cardboard/paper, a fabric, concrete, or metal.

20. The method of claim 12, wherein the biobased coating solution comprises about 0.1 to about 40% w/w of a plasticizer and the plasticizer is at least one of glycerol, a sugar alcohol, and a polyol.

21. The method of claim 12, further comprising performing at least one of:
adding a pigment to the biobased coating solution; and
adding a viscosity modifier to the biobased coating solution.

22. (canceled)

23. The method of claim 12, wherein the cellulose is at least one of microfibrillated cellulose (MFC) and nano crystalline cellulose (NCC).

24. The method of claim 12, wherein the lignin is sourced from any one of plants, softwood, hardwood, grasses, jute, hemp, cotton, sugarcane, straw, grass, and nut residue.

25. The method of claim 12, wherein the cellulose is sourced from any one of cotton, hemp, flax, jute, algae, bacteria, and wood.

26. The method of claim 12, wherein the substrate comprises any one of paper, pulp, starch, mushroom (including mycelium), seaweed, corrugated cardboard, uncorrugated cardboard, recycled cardboard/paper, a fabric, concrete, and metal.

27. The method of claim 12, wherein the lignin in the biobased coating solution is less than about 10% w/w.

28. The method of claim 13, wherein the substrate is treated with the acid, and said treating the substrate with the acid comprises contacting the biobased coating with an acid having a pH below 4.0.
